(19) United States
(12) Patent Application Publication
(10) Pub. No.: US 2025/0254737 A1
(43) Pub. Date: Aug. 7, 2025

(54) RESOURCE HANDLING IN CELL SWITCH

(71) Applicant: NOKIA TECHNOLOGIES OY, Espoo (FI)

(72) Inventors: Samuli Heikki Turtinen, Ii (FI); Timo Koskela, Oulu (FI); Endrit Dosti, Espoo (FI)

(21) Appl. No.: 19/042,734

(22) Filed: Jan. 31, 2025

(30) Foreign Application Priority Data
Feb. 2, 2024 (FI) 20245110

(51) Int. Cl. H04W 74/0838; H04W 74/0836

(52) U.S. Cl. CPC H04W 74/0838; H04W 74/0836

(57) ABSTRACT

Example embodiments of the disclosure relate to methods, apparatuses, and a computer readable storage medium for handling contention free random access (CFRA) resources in a cell switch. In a method, a first apparatus receives, from a second apparatus, a configuration indicating CFRA resources for at least one candidate cell. The first apparatus receives, from the second apparatus, a cell switch command towards a first candidate cell. In accordance with a determination that a first cell switch to the first candidate cell fails, the first apparatus determines a second candidate cell for a second cell switch. The second candidate cell being one of the at least one candidate cell. Then the first apparatus discards CFRA resources for the second candidate cell.

### PRIORITY

This application claims priority to Finnish Application No. 20245110, filed on Feb. 2, 2024, entitled “RESOURCE HANDLING IN CELL SWITCH”, the entirety of which is hereby incorporated by reference.

### FIELDS

Various example embodiments of the present disclosure generally relate to the field of telecommunication and in particular, to methods, apparatuses and a computer readable storage medium for handling contention free random access (CFRA) resources in a cell switch.

### BACKGROUND

A Layer 1 or Layer 2 (L1/L2) triggered mobility (LTM) procedure is provided for handover of a terminal device (e.g., UE) from a source cell to a target cell. In the LTM procedure, a network device (e.g., gNB) receives L1 measurement report(s) from a UE, and on their basis the gNB changes UE serving cell by a cell switch command signalled via a Medium Access Control Control Element (MAC CE). The cell switch command indicates an LTM candidate configuration that the gNB previously prepared and provided to the UE through Radio Resource Control (RRC) signalling. Then the UE switches to the target configuration according to the cell switch command. The LTM procedure may be used to reduce the mobility latency.

### SUMMARY

In a first aspect of the present disclosure, there is provided a first apparatus. The first apparatus comprises at least one processor; and at least one memory storing instructions that, when executed by the at least one processor, cause the first apparatus at least to: receive, from a second apparatus, a configuration indicating CFRA resources for at least one candidate cell; receive, from the second apparatus, a cell switch command towards a first candidate cell; in accordance with a determination that a first cell switch to the first candidate cell fails, determine a second candidate cell for a second cell switch, the second candidate cell being comprised in the at least one candidate cell; and discard CFRA resources for the second candidate cell.

In a second aspect of the present disclosure, there is provided a second apparatus. The second apparatus comprises at least one processor; and at least one memory storing instructions that, when executed by the at least one processor, cause the second apparatus at least to: transmit, to a first apparatus, a configuration indicating CFRA resources for at least one candidate cell; and transmit, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

In a third aspect of the present disclosure, there is provided a method. The method comprises: receiving, from a second apparatus, a configuration indicating CFRA resources for at least one candidate cell; receiving, from the second apparatus, a cell switch command towards a first candidate cell; in accordance with a determination that a first cell switch to the first candidate cell fails, determining a second candidate cell for a second cell switch, the second candidate cell being comprised in the at least one candidate cell; and discarding CFRA resources for the second candidate cell.

In a fourth aspect of the present disclosure, there is provided a method. The method comprises: transmitting, to a first apparatus, a configuration indicating CFRA resources for at least one candidate cell; and transmitting, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

In a fifth aspect of the present disclosure, there is provided a first apparatus. The first apparatus comprises means for receiving, from a second apparatus, a configuration indicating CFRA resources for at least one candidate cell; means for receiving, from the second apparatus, a cell switch command towards a first candidate cell; means for in accordance with a determination that a first cell switch to the first candidate cell fails, determining a second candidate cell for a second cell switch, the second candidate cell being comprised in the at least one candidate cell; and means for discarding CFRA resources for the second candidate cell.

In a sixth aspect of the present disclosure, there is provided a second apparatus. The second apparatus comprises means for transmitting, to a first apparatus, a configuration indicating CFRA resources for at least one candidate cell; and means for transmitting, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

In a seventh aspect of the present disclosure, there is provided a computer readable medium. The computer readable medium comprises instructions stored thereon for causing an apparatus to perform at least the method according to the third aspect.

In an eighth aspect of the present disclosure, there is provided a computer readable medium. The computer readable medium comprises instructions stored thereon for causing an apparatus to perform at least the method according to the fourth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments may now be described with reference to the accompanying drawings, where:

FIG. 1 illustrates an example communication environment in which example embodiments of the present disclosure can be implemented;

FIG. 2 illustrates a signalling flow for handling CFRA resources according to some example embodiments of the present disclosure;

FIG. 3 illustrates an example LTM cell switch command Medium Access Control (MAC) Control Element (CE);

FIG. 4A illustrates a signalling flow for handling CFRA resources according to some example embodiments of the present disclosure;

FIG. 4B illustrates a signalling flow for handling CFRA resources according to some example embodiments of the present disclosure;

FIG. 5 illustrates a flowchart of a method implemented at a first apparatus according to some example embodiments of the present disclosure;

FIG. 6 illustrates a flowchart of a method implemented at a second apparatus according to some example embodiments of the present disclosure;

FIG. 7 illustrates a simplified block diagram of a device that is suitable for implementing example embodiments of the present disclosure; and

FIG. 8 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure may now be described with reference to some example embodiments. It is to be understood that these embodiments are described only for the purpose of illustration and help those skilled in the art to understand and implement the present disclosure, without suggesting any limitation as to the scope of the disclosure. Embodiments described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first,” “second,” . . . , etc., in front of noun(s) and the like may be used herein to describe various elements, these elements should not be limited by these terms. These terms are only used to distinguish one element from another and they do not limit the order of the noun(s). For example, a first element could be termed a second element, and similarly, a second element could be termed a first element, without departing from the scope of example embodiments. As used herein, the term “and/or” includes any and all combinations of one or more of the listed terms.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used herein, unless stated explicitly, performing a step “in response to A” does not indicate that the step is performed immediately after “A” occurs and one or more intervening steps may be included.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It may be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), the sixth generation (6G) communication protocols, and/or any other protocols either currently known or to be developed in the future. Embodiments of the present disclosure may be applied in various communication systems. Given the rapid development in communications, there may of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an Integrated Access and Backhaul (IAB) node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture includes a Centralized Unit (CU) and a Distributed Unit (DU) at an IAB donor node. An IAB node includes a Mobile Terminal (IAB-MT) part that behaves like a UE toward the parent node, and a DU part of an IAB node behaves like a base station toward the next-hop IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an IAB node (e.g., a relay node). In the following description, the terms “terminal device”, “communication device”, “terminal”, “user equipment” and “UE” may be used interchangeably.

As used herein, the term “resource,” “transmission resource,” “resource block,” “physical resource block” (PRB), “uplink resource,” or “downlink resource” may refer to any resource for performing a communication, for example, a communication between a terminal device and a network device, such as a resource in time domain, a resource in frequency domain, a resource in space domain, a resource in code domain, or any other combination of the time, frequency, space and/or code domain resource enabling a communication, and the like. In the following, unless explicitly stated, a resource in both frequency domain and time domain may be used as an example of a transmission resource for describing some example embodiments of the present disclosure. It is noted that example embodiments of the present disclosure are equally applicable to other resources in other domains.

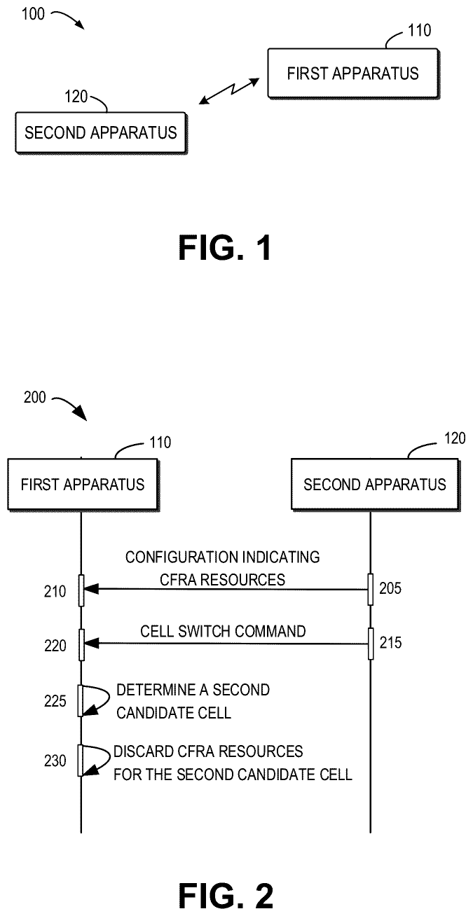

FIG. 1 illustrates an example communication environment 100 in which example embodiments of the present disclosure can be implemented. In the communication environment 100. In the communication environment 100, a plurality of communication devices, including a first apparatus 110 and a second apparatus 120 can communicate with each other.

In the example of FIG. 1, the second apparatus 120 has a certain coverage range, which may be called as a serving area or a source cell. The first apparatus 110 is located in the cell managed by the second apparatus 120. In the communication environment 100, the second apparatus 120 may communicate data and control information with the first apparatus 110.

In some example embodiments, if the first apparatus 110 is a terminal device and the second apparatus 120 is a network device, a link from the second apparatus 120 to the first apparatus 110 is referred to as a downlink (DL), while a link from the first apparatus 110 to the second apparatus 120 is referred to as an uplink (UL). In DL, the second apparatus 120 is a transmitting (TX) device (or a transmitter) and the first apparatus 110 is a receiving (RX) device (or a receiver). In UL, the first apparatus 110 is a TX device (or a transmitter) and the second apparatus 120 is a RX device (or a receiver).

It is to be understood that the number of apparatuses and their connections shown in FIG. 1 are only for the purpose of illustration without suggesting any limitation. The communication environment 100 may include any suitable number of apparatuses configured to implement example embodiments of the present disclosure.

In the following, for purposes of illustration, some example embodiments are described with the first apparatus 110 operating as a terminal device and the second apparatus 120 operating as a network device. However, in some example embodiments, operations described in connection with a terminal device may be implemented at a network device or other device, and operations described in connection with a network device may be implemented at a terminal device or other device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

As discussed above, a time-based handover failure procedure is supported in NR. A Radio Resource Control (RRC) connection re-establishment procedure is used for recovering from handover failure, except in certain conditional handover (CHO), dual active protocol stack (DAPS) handover or LTM cell switch scenarios.

In a CHO scenario, when initial CHO execution attempt fails or handover fails, a terminal device performs cell selection. If a selected cell is a CHO candidate and if a network device has configured the terminal device to try CHO after handover/CHO failure, the terminal device attempts CHO execution once, otherwise a re-establishment procedure is performed.

In a DAPS handover scenario, when the DAPS handover fails, a terminal device falls back to a source cell configuration, resumes a connection with a source cell, and reports the DAPS handover failure via a source link without triggering RRC connection re-establishment if the source link has not been released.

In a LTM cell switch scenario, when an initial LTM execution attempt fails or handover fails, a terminal device performs cell selection. If a selected cell is an LTM candidate cell and if a network device has configured the terminal device to try LTM after LTM execution failure, the terminal device attempts LTM execution once, otherwise a re-establishment procedure is performed.

LTM is a procedure in which a network device receives L1 measurement report(s) from a terminal device, and the network device changes the serving cell if the terminal device by a cell switch command based on the received L1 measurement report(s). The cell switch command is signalled via a MAC CE. The cell switch command indicates an LTM candidate configuration that the network device previously prepared and provided to the terminal device through RRC signalling. Then the terminal device switches to the target configuration according to the cell switch command. The LTM procedure can be used to reduce mobility latency.

When configured by the network device, it is possible to activate Transmission Configuration Index (TCI) states of one or more cells that are different from the current serving cell. For instance, the TCI states of the LTM candidate cells can be activated in advance before any of those cells become the serving cell. This allows the terminal device to be downlink (DL) synchronized with those LTM candidate cells, thereby facilitating a faster cell switch to one of those cells when cell switch is triggered.

When configured by the network device, it is possible to initiate a uplink (UL) Timing advance (TA) acquisition (called early TA acquisition) procedure of one or more cells that are different from the current serving cell. If a cell has the same N_{TA} as the current serving cells or N_{TA}=0, an early TA acquisition procedure is not required. The network device may request a terminal device to perform an early TA acquisition procedure for a candidate cell before a cell switch. The early TA acquisition procedure is triggered by Physical Downlink Control Channel (PDCCH) order or realized through UE-based TA measurement as configured by RRC. In the former case, the network device to which the candidate cell belongs calculates a TA value and sends it to that network device. The serving cell sends the TA value in the LTM cell switch command MAC CE when triggering LTM cell switch. In the latter case, the terminal device performs TA measurement for a candidate cell after being configured by RRC. The exact time the terminal device performs the TA measurement depends on the implementation of the terminal device. The terminal device applies a TA value measured by itself via the TA measurement and performs Random Access Channel (RACH)-less LTM upon receiving a cell switch command. Alternatively, a TA value may be obtained from a network device in the LTM cell switch command MAC CE, without early TA acquisition.

Depending on the availability of a valid TA value, the terminal device performs either a RACH-less LTM or RACH-based LTM cell switch. If the TA value is provided in a cell switch command, the terminal device applies the TA value as instructed by the network device. In the case where UE-based TA measurement is configured, but no TA value is provided in the cell switch command, the terminal device applies the TA value measured by itself if available. Meanwhile, the terminal device performs RACH-less LTM cell switch upon receiving the cell switch command. If no valid TA value is available, the terminal device performs RACH-based LTM cell switch.

Regardless of whether the terminal device is configured with UE-based TA measurement for a certain candidate cell, it follows the PDCCH order, which includes requesting a random access procedure towards candidate cells. This is also applied to candidate cells for which the terminal device is capable of measuring TA values by itself. Alternatively or in addition, regardless of whether the terminal device has already performed a random access procedure towards the candidate cells, it follows the UE-based measurement configuration if configured by a network device.

For RACH-less LTM, the terminal device accesses a target cell using either a configured grant or a dynamic grant. The configured grant is provided in a LTM candidate configuration. The terminal device selects a configured grant occasion associated with a beam indicated in the cell switch command. Upon initiating a LTM cell switch to the target cell, the terminal device starts to monitor PDCCH on the target cell for dynamic scheduling. Before a RACH-less LTM procedure is completed, the terminal devices will not trigger a random access procedure if it does not have a valid Physical Uplink Control Channel (PUCCH) resource for triggered Scheduling Requests (SRs).

There are some principles that may be applied to LTM. One of the principles is that a security key is maintained upon an LTM cell switch. The other one of the principles is that subsequent LTM is supported.

LTM supports both intra-gNB-DU and intra-gNB-CU inter-gNB-DU mobility. LTM supports both intra-frequency and inter-frequency mobility, including mobility to inter-frequency cell that is not a current serving cell. LTM is supported only for licensed spectrum. The following scenarios are supported:
PCell change in non-CA scenario and non-DC scenario;
Pcell and Scell(s) change in CA scenario;
Dual connectivity scenario, Pcell and MCG Scell(s) change and intra-SN PSCell and SCG Scell(s) change without MN involvement. LTM for simultaneous Pcell and PSCell change is not supported.

While the terminal device has stored LTM candidate configurations the terminal device may also execute any Layer 3 (L3) handover command sent by the network device.

RRC provided CFRA resources may be pre-provisioned to the UE for any LTM candidate in the ltm-Config (R2-2313672), (TS 38.331 v18.0.0). Table 1 shows an example of a part of the LTM configuration.

TABLE 1
- LTM-CandidateId
The IE LTM-CandidateId is used to identify an LTM candidate configuration.

LTM-CandidateId information element

-- ASN1START
-- TAG-LTM-CANDIDATEID-START

| | |
|---|---|
| LTM-CandidateId-r18 ::= | INTEGER (1..maxNrofLTM-Configs-r18) |

-- TAG-LTM-CANDIDATEID-STOP
-- ASN1STOP
- LTM-Candidate
The IE LTM-Candidate concerns a LTM candidate configuration to add or modify.

LTM-Candidate information element

-- ASN1START
-- TAG-LTM-CANDIDATE-START

| | |
|---|---|
| LTM-Candidate-r18 ::= | SEQUENCE { |
| ltm-CandidateId-r18 | LTM-CandidateId-r18, |
| ltm-CandidatePCI-r18 | PhysCellId, |
| ltm-SSB-Config-r18 | LTM-SSB-Config-r18 OPTIONAL, |

-- Need M

| | |
|---|---|
| ltm-CandidateConfig-r18 | OCTET STRING (CONTAINING RRCReconfiguration) |

OPTIONAL, -- Need M

| | |
|---|---|
| ltm-ConfigComplete-r18 | ENUMERATED {true} |

OPTIONAL, -- Need R

| | |
|---|---|
| ltm-EarlyUL-SyncConfig-r18 | SetupRelease { EarlyUL-SyncConfig-r18 } |

OPTIONAL, -- Need M

| | |
|---|---|
| ltm-EarlyUL-SyncConfigSUL-r18 | SetupRelease { EarlyUL-SyncConfig-r18 } |

OPTIONAL, -- Need M

| | |
|---|---|
| ltm-NoResetID-r18 | INTEGER (1..maxNrofLTM-Configs-r18-plus-1) |

OPTIONAL, -- Need M

| | |
|---|---|
| ltm-DL-OrJointTCI-StateToAddModList-r18 | SEQUENCE (SIZE (1..maxNrofCandidateTCI- |

State-r18)) OF CandidateTCI-State-r18

| | |
|---|---|
| | OPTIONAL, -- Need N |
| ltm-DL-OrJointTCI-StateToReleaseList-r18 | SEQUENCE (SIZE (1..maxNrofCandidateTCI- |

State-r18)) OF TCI-StateId

| | |
|---|---|
| | OPTIONAL, -- Need N |
| ltm-UL-TCI-StatesToAddModList-r18 | SEQUENCE (SIZE (1..maxNrofCandidateUL- |

TCI-r18)) OF CandidateTCI-UL-State-r18

| | |
|---|---|
| | OPTIONAL, -- Need N |
| ltm-UL-TCI-StatesToReleaseList-r18 | SEQUENCE (SIZE (1..maxNrofCandidateUL-TCI- |

r18)) OF TCI-UL-StateId-r17

| | |
|---|---|
| | OPTIONAL, -- Need N |
| ltm-nzp-CSI-RS-ResourceToAddModList-r18 | SEQUENCE (SIZE (1..maxNrofNZP-CSI-RS- |

Resources)) OF NZP-CSI-RS-Resource

| | |
|---|---|
| | OPTIONAL, -- Need N |
| ltm-nzp-CSI-RS-ResourceToReleaseList-r18 | SEQUENCE (SIZE (1..maxNrofNZP-CSI-RS- |

Resources)) OF NZP-CSI-RS-ResourceId

| | |
|---|---|
| | OPTIONAL, -- Need N |
| ltm-nzp-CSI-RS-ResourceSetToAddModList-r18 | SEQUENCE (SIZE (1..maxNrofNZP-CSI- |

RS-ResourceSets)) OF NZP-CSI-RS-ResourceSet

| | |
|---|---|
| | OPTIONAL, -- Need N |
| ltm-nzp-CSI-RS-ResourceSetToReleaseList-r18 | SEQUENCE (SIZE (1..maxNrofNZP-CSI-RS- |

ResourceSets)) OF NZP-CSI-RS-ResourceSetId

| | |
|---|---|
| | OPTIONAL, -- Need N |
| pathlossReferenceRS-ToAddModList-r18 | SEQUENCE (SIZE |

(1..maxNrofPathlossReferenceRSs-r17)) OF PathlossReferenceRS-r17

| | |
|---|---|
| | OPTIONAL, -- Need N |
| pathlossReferenceRS-ToReleaseList-r18 | SEQUENCE (SIZE |

(1..maxNrofPathlossReferenceRSs-r17)) OF PathlossReferenceRS-Id-r17

| | |
|---|---|
| | OPTIONAL, -- Need N |
| ltm-UE-MeasuredTA-ID-r18 | INTEGER (1..maxNrofLTM-Configs-r18-plus-1) |

OPTIONAL, -- Need M
...
}
LTM-SSB-Config-r18 ::= SEQUENCE {

| | |
|---|---|
| ssbFrequency-r18 | ARFCN-ValueNR, |
| subCarrierSpacing-r18 | SubCarrierSpacing, |
| ssb-Periodicity-r18 | ENUMERATED {ms5, ms10, ms20, ms40, ms80, ms160, |
| spare2, spare1} | OPTIONAL, -- Need R |
| ssb-PositionsInBurst-r18 | CHOICE { |
| shortBitmap | BIT STRING (SIZE (4)), |
| mediumBitmap | BIT STRING (SIZE (8)), |
| longBitmap | BIT STRING (SIZE (64)) |
| } | OPTIONAL, -- Need R |
| ss-PBCH-BlockPower-r18 | INTEGER (−60..50) |

OPTIONAL, -- Need R
...
}
-- TAG-LTM-CANDIDATE-STOP
-- ASN1STOP
- LTM-Config
The IE LTM-Config is used to provide LTM candidate configurations.

LTM-Config information element

-- ASNISTART
-- TAG-LTM-CONFIG-START
LTM-Config-r18 ::= SEQUENCE {

| | |
|---|---|
| ltm-ReferenceConfiguration-r18 | SetupRelease {ReferenceConfiguration-r18} |

OPTIONAL, -- Need M

| | |
|---|---|
| ltm-CandidateToReleaseList-r18 | SEQUENCE (SIZE (1..maxNrofLTM-Configs-r18)) OF |
| LTM-CandidateId-r18 | OPTIONAL, -- Need N |
| ltm-CandidateToAddModList-r18 | SEQUENCE (SIZE (1..maxNrofLTM-Configs-r18)) OF |
| LTM-Candidate-r18 | OPTIONAL, -- Need N |
| ltm-ServingCellNoResetID-r18 | INTEGER (1..maxNrofLTM-Configs-r18-plus-1) |

OPTIONAL, -- Cond FirstLTM-Only

| | |
|---|---|
| ltm-CSI-ResourceConfigToAddModList-r18 | SEQUENCE (SIZE (1..maxNrofLTM-CSI- |

ResourceConfigurations-r18)) OF LTM-CSI-ResourceConfig-r18

| | |
|---|---|
| | OPTIONAL, -- Need N |
| ltm-CSI-ResourceConfigToReleaseList-r18 | SEQUENCE (SIZE (1..maxNrofLTM-CSI- |

ResourceConfigurations-r18)) OF LTM-CSI-ResourceConfigId-r18

| | |
|---|---|
| | OPTIONAL, -- Need N |
| attemptLTM-Switch-r18 | ENUMERATED {true} |

OPTIONAL, -- Cond LTM-MCG

| | |
|---|---|
| ltm-ServingCellUE-MeasuredTA-ID-r18 | INTEGER (1..maxNrofLTM-Configs-r18-plus-1) |

OPTIONAL, -- Cond LTM
...
}
-- TAG-LTM-CONFIG-STOP
-- ASN1STOP

The RRCReconfiguration above includes the Reconfiguration With Sync information element (IE) for LTM. Table 2 shows an example of the RRC reconfiguration.

TABLE 2
5.3.5 RRC reconfiguration
5.3.5.1 General
RRC reconfiguration to perform reconfiguration with sync includes, but is not limited to, the
following cases:

| - | reconfiguration with sync for LTM cell switch (without security key refresh), and | |
|---|---|---|
| | - | involving or not involving RA to the target LTM candidate SpCell according to a |
| | | network indication; |
| | - | MAC reset; |
| | - | depending on a network indication, re-establishment of RLC and PDCP data recovery |
| | | (for AM DRB). |
| - | reconfiguration with sync for LTM cell switch (without security key refresh), and | |
| | - | involving or not involving RA to the target LTM candidate SpCell according to a |
| | | network indication; |
| | - | MAC reset; |

| | |
|---|---|
| - | depending on a network indication, no re-establishment of RLC. |

| | |
|---|---|
| - | CellGroupConfig |

The CellGroupConfig IE is used to configure a master cell group (MCG) or secondary cell group
(SCG). A cell group comprises of one MAC entity, a set of logical channels with associated
RLC entities and of a primary cell (SpCell) and one or more secondary cells (SCells).

| | |
|---|---|
| | CellGroupConfig information element |
| ReconfigurationWithSync ::= | SEQUENCE { |
| spCellConfigCommon | ServingCellConfigCommon OPTIONAL, |

-- Need M

| | |
|---|---|
| newUE-Identity | RNTI-Value, |
| t304 | ENUMERATED {ms50, ms100, ms150, ms200, ms500, ms1000, |

ms2000, ms10000},

| | |
|---|---|
| rach-ConfigDedicated | CHOICE { |
| uplink | RACH-ConfigDedicated, |
| supplementaryUplink | RACH-ConfigDedicated |
| } | OPTIONAL, -- Need N |

In the LTM cell switch scenario described above, if the initial LTM attempt (as ordered by the network device with LTM Cell Switch Command MAC CE) fails, the terminal device selects a new cell. If the new cell is configured as a LTM candidate cell, the terminal device performs a LTM cell switch procedure for the selected cell.

In a RRC connection re-establishment procedure, after cell selection is performed, the LTM cell switch procedure for the selected LTM candidate cell may be performed in the following case, for example, but not limited to: a) if the cell selection is triggered by detecting radio link failure of the Master Cell Group (MCG) or re-configuration with sync failure of the MCG or mobility from NR failure; b) if LTM-Switch attempt is configured; and c) if the selected cell is one of the LTM candidate cells in the LTM-Candidate Information Element (IE) within VarLTM-Config associated with the MCG.

In legacy LTM cell switch, a network device triggers LTM cell switch with a LTM CSC MAC CE and a terminal device performs LTM cell switch towards a indicated target cell. However, the LTM cell switch may fail. As explained above, in case that the LTM cell switch fails, a terminal device triggers a LTM recovery procedure and performs a cell selection procedure to select a cell. If the selected cell is an LTM candidate cell, the terminal device performs a LTM cell switch procedure towards the selected cell. If the LTM recovery procedure is successful, the terminal device keeps LTM configurations that were initially configured by the network device.

In this case, the terminal device may have been pre-provisioned with CFRA resources by the network device to be used for the selected cell in the LTM recovery procedure. Since the network indicates LTM cell switch procedures towards different target cell, NW may have already re-assigned the pre-provisioned CFRA resources for another terminal device. Hence, when a RA procedure is triggered based on the cell switch procedure, the terminal device applies the pre-provisioned CFRA resources in the RA procedure, which may be problematic and unexpected by the network. Furthermore, there is a need to solve a problem of how to handle the pre-provisioned CFRA resources that are assigned in the LTM CSC MAC CE when a LTM cell switch fails and/or a LTM recovery procedure is triggered.

According to some example embodiments of the present disclosure, a solution for handling CFRA resources is proposed. In the solution, a terminal device receives a configuration indicating CFRA resources for at least one candidate cell and optionally with an indication indicating whether the CFRA resources for a second candidate cell are allowed to be used for a second cell switch in a case where a first cell switch to a first candidate cell fails. The terminal device further receives a cell switch command towards a first candidate cell. If a first cell switch to the first candidate cell fails, the terminal device determines a second candidate cell for a second cell switch, which is included in the at least one candidate cell. Then, the terminal device discards CFRA resources for the second candidate cell. In this way, the CFRA resources pre-provisioned for LTM candidate cells can be handled upon a LTM recovery procedure (i.e., a LTM cell switch procedure triggered after the RLF and cell selection) and a resource conflict can be avoided.

Example embodiments of the present disclosure will be described in detail below with reference to the accompanying drawings.

FIG. 2 illustrates a signalling flow 200 for handling random access resources according to some example embodiments of the present disclosure. For the purposes of discussion, the signalling flow 200 will be discussed with reference to FIG. 1. The signalling flow involves a first apparatus 110 and a second apparatus 120. For the purpose of illustration, some example embodiments may be described with the first apparatus 110 operating as a terminal device (for example, a UE) and the second apparatus 120 operating as a network device (for example, a gNB).

In II the signalling flow 200, the second apparatus 120 transmits (205) a configuration indicating CFRA resources to the first apparatus 110. The CFRA resources is used for at least one candidate cell. The candidate cell(s) may act as candidates for a cell switch or a handover process. In some example embodiments, the cell switch may be a LTM cell switch. In such cases, the candidate cell(s) may be used for the LTM cell switch. In the case where the cell switch is a LTM cell switch, the configuration received by the first apparatus 110 may be a LTM configuration.

In some example embodiments, the CFRA resources may be 4-step Random Access (RA) resources or 2-step RA resources. According to some aspects, RACH can include a 2-step RA procedure and/or a 4-step RA procedure. For example, in Rel-15, the 4-step RA procedure is configured for the UE to perform its initial access. In Rel-16, both 4-step RA and 2-step RA procedures may be configured within one cell for the UE to its perform initial access. The 2-step and 4-step RACH resources can be differentiated using different ROs and/or preamble combination. According to some aspects, the 2-step RACH and 4-step RA procedures can be based on, for example, Technical Specifications (TS) 38.211 Section 6.3.3.2, TS 38.213 Section 8, and/or TS 38.321 Section 5.1.

The first apparatus 110 receives (210) the configuration from the second apparatus 120. Thus, the second apparatus 120 has the knowledge of the CFRA resources for the at least one candidate cell.

As shown in FIG. 2, the second apparatus 120 transmits (215) a cell witch command towards a first candidate cell to the first apparatus 110. The first apparatus 110 further receives (220) the cell switch command from the second apparatus 120. In some example embodiments, the first apparatus 110 may determine the first candidate cell based on a target configuration index in the cell switch command. Thus, upon receiving (220) the cell switch command, the first apparatus 110 will be aware of the target cell (in this case, the first candidate cell) for the upcoming cell switch, and may perform the cell switch (also referred to as “first cell switch” for discussion) accordingly.

An example implementation of the LTM cell switch command will be discussed below in Table 3 by taking the third generation partnership project (3GPP) TS 38.321 v18.0.0 as an example.

TABLE 3

| | |
|---|---|
| 5.18.xy | LTM Cell Switch Command |

The network may instruct the UE to perform LTM cell switch procedure by sending
the LTM Cell Switch Command MAC CE described in clause 6.1.3.xy.
The MAC entity shall:

| 1> | if the MAC entity receives an LTM Cell Switch Command MAC CE on a | |
|---|---|---|
| | Serving Cell: | |
| | 2> | indicate to upper layers that the LTM cell switch procedure is triggered and |

| | the Target Configuration ID included in the MAC CE; |
|---|---|
| 2> | if the MAC reset operation as specified in sub-clause 5.12 is performed, as |

| requested by upper layers: | |
|---|---|
| 3> | if Random Access procedure is needed for the LTM cell switch: |

| 4> | if the indication to discard contention-free Random Access resources is |
|---|---|
| received; or | |
| 4> | if the discardTimerCFRA is not running: |

| 5> | discard any explicitly signalled contention-free Random Access |
|---|---|
| | Resources for 2-step RA type and 4-step RA type except the 4-step |
| | RA type contention-free Random Access Resources for beam failure |
| | recovery request, if any, (OPTIONAL) for the LTM target cell as |
| | indicated by the Target Configuration ID. |
| 5> | if the indication to discard contention-free Random Access resources for |

| all LTM candidate cells is received: | |
|---|---|
| 6> | discard any explicitly signalled contention-free Random Access |

Resources for 2-step RA type and 4-step RA type except the 4-step
RA type contention-free Random Access Resources for beam failure
recovery request, if any, for all the LTM candidate cells configured
by upper layers.

| | |
|---|---|
| 4> | initiate a Random Access procedure (see clause 5.1) for the LTM cell |

| | switch. |
|---|---|
| 3> | else if Timing Advance Command value (hexa-decimal) is not set as FFF: |

| | |
|---|---|
| 4> | process the received Timing Advance Command (see clause 5.2); |
| 4> | consider the RACH-less LTM cell switch to be ongoing; |
| 4> | if the MAC entity is associated with SCG: |

| | |
|---|---|
| 5> | indicate to upper layers to skip the Random Access procedure for this |

LTM cell switch.

| | |
|---|---|
| 3> | else if the Timing Advance measurement is configured as specified in |

TS 38.331 [5] and the UE has successfully measured the Timing Advance
for the indicated LTM target:

| | |
|---|---|
| 4> | process the measured Timing Advance (see clause 5.2); |
| 4> | consider the RACH-less LTM cell switch to be ongoing. |
| 4> | if the MAC entity is associated with SCG: |

| | |
|---|---|
| 5> | indicate to upper layers to skip the Random Access procedure for this |

LTM cell switch.

| | |
|---|---|
| 3> | if TCI state information is included: |

| 4> | consider the SSB corresponding to the indicated TCI state as the one |
|---|---|
| used for configured uplink grant selection for the initial uplink transmission | |
| towards the candidate cell for RACH-less LTM cell switch (as in clause 5.8.2); | |
| 4> | indicate to lower layers the information regarding the TCI state |

information included in the LTM Cell Switch Command MAC CE.

An example implementation of the LTM Cell Switch Command MAC CE will be discussed below in Table 4 by taking 3GPP TS 38.321 v18.0.0 as an example.

TABLE 4
6.1.3.xy LTM Cell Switch Command MAC CE

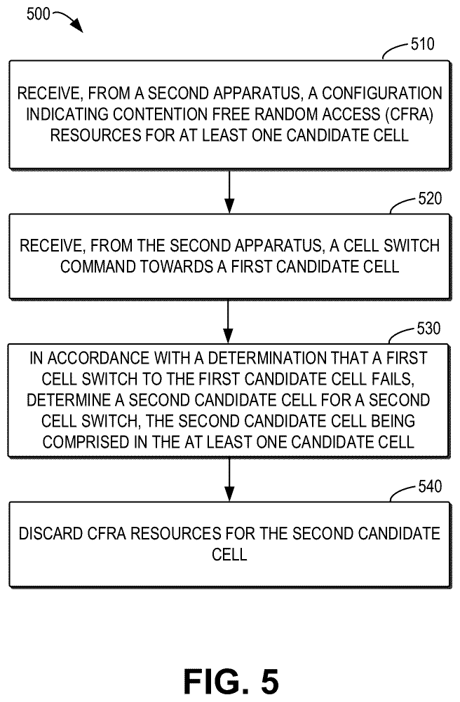

The LTM Cell Switch Command MAC CE is identified by MAC subheader with
eLCID as specified in Table 6.2.1-1b. It has a variable size with following fields
(FIG. 5):
R: Reserved bit, set to 0;
Target Configuration ID: This field indicates the index of candidate target
configuration to apply for LTM cell switch, corresponding to ltm-CandidateId
minus 1 as specified in TS 38.331 [5]. The length of the field is 3 bits;
Timing Advance Command: This field indicates whether the TA is valid for the
LTM target cell (i.e., the SpCell corresponding to the target configuration
indicated by Target Configuration ID field). If the value of this field is set to FFF,
this field indicates that no valid timing adjustment is available for the PTAG of the
LTM target cell; Otherwise, this field indicates the index value T_{A} used to control
the amount of timing adjustment that the MAC entity has to apply in TS 38.213
[6], and that the UE can skip the Random Access procedure for this LTM cell
switch. The length of the field is 12 bits;
TCI state ID: This field indicates and activates the TCI state for the LTM target
cell (i.e., the SpCell of the target configuration indicated by the Target
Configuration ID field). The TCI state is identified by TCI-Stateld in Itm-DL-
OrJointTCI-StateToAddModList as specified in TS 38.331 [5]. If the value of
unifiedTCI-StateType in the configuration indicated by Target Configuration ID
field is joint, this field is for joint TCI state, otherwise, this field is for downlink
TCI state. The length of the field is 7 bits;
UL TCI state ID: This field indicates and activates the uplink TCI state for the
LTM target cell (i.e., the SpCell of the target configuration indicated by the
Target Configuration ID field). The most significant bits of UL TCI state ID are
considered as reserved bits and the remainder 6 bits indicate the TCI-UL-Stateld
in Itm-UL-TCI-StatesToAddModList as specified in TS 38.331 [5]. This field is
included if the value of unifiedTCI-StateType in the configuration indicated by
Target Configuration ID field is separate. The length of the field is 8 bits;
C: This field indicates the presence of the contention-free Random Access
Resources fields. If the value of this field is set to 1, the following fields are
present, including Random Access Preamble index field, S/U field, SS/PBCH
index field and PRACH Mask index field. If the value of this field is set to 0,
Random Access Preamble index field, SS/PBCH index field and PRACH Mask
index field are absent, and S/U field is considered as Reserved field.
S/U: This field indicates which UL carrier to transmit the PRACH of the
contention-free Random Access Resources. If the value of this field is set to 1,
SUL is used; otherwise, NUL is used. The length of the field is 1 bit;
DR: This field indicates whether the UE shall discard any explicitly signalled
contention-free Random Access resources on only on the LTM target cell as
indicated by the Target Configuration ID or all the LTM candidate cells
configured by upper layers. // This field indicates whether the UE shall discard
any explicitly signalled contention-free Random Access resources and initiate a
Random Access procedure (as specified in clause 5.18.xy). If the field is set to 1,
CFRA resources shall be discarded and RA procedure initiated; otherwise, no RA
procedure is initiated. The length of the field is 1 bit;
Random Access Preamble index: This field indicates the Random Access
Preamble index of the contention-free Random Access Resources. If the field is
set to 0b000000, the UE shall discard any explicitly signalled contention-free
Random Access resources before initiating Random Access procedure
(as specified in clause 5.18.xy). // If the field is set to 0b000000, the UE shall
initiate Random Acess procedure (as specified in clause 5.18.xy). The length of
the field is 6 bits;
SS/PBCH index: This field indicates the SS/PBCH that shall be used to determine
the RACH occasion for the PRACH transmission of the contention-free Random
Access Resources. The length of the field is 6 bits;
PRACH Mask index: This field indicates the RACH occasion(s) associated with
the SS/PBCH indicated by “SS/PBCH index” for the PRACH transmission of the
contention-free Random Access Resources, referring to the rach-ConfigDedicated
(if not provided otherwise to the rach-ConfigCommon) in the UL BWP
configuration of firstActiveUplinkBWP-Id as specified in TS 38.331 [5].
The length of the field is 4 bits;

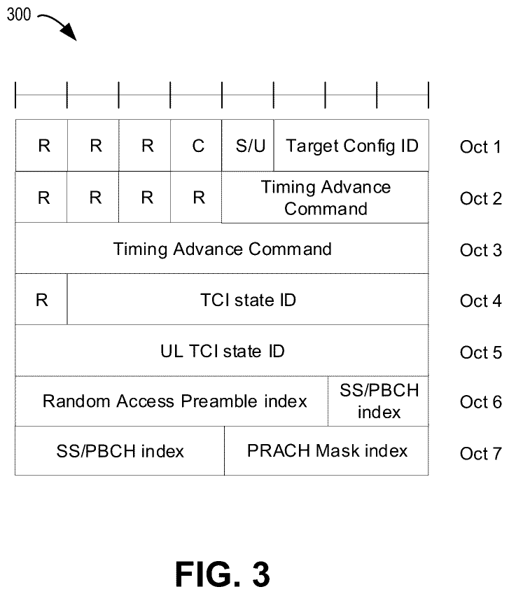

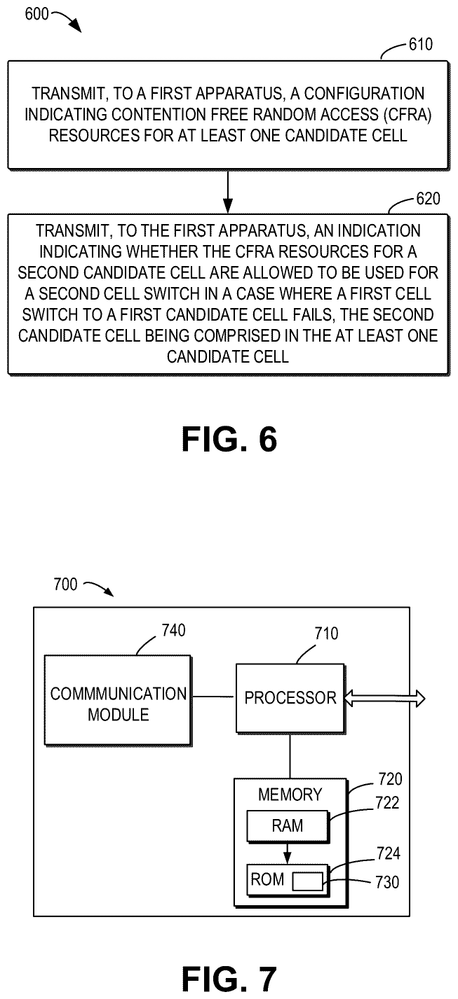

FIG. 3 corresponds to the FIG. 6.1.3.xy-1 discussed in Table 4. FIG. 3 illustrates an example of a LTM Cell Switch Command MAC CE. The content in the LTM Cell Switch Command MAC CE has been discussed with reference to Table 4 as discussed above.

Still referring to FIG. 2, if a first cell switch to the first candidate cell fails, the first apparatus 110 determines (225) a second candidate cell for a second cell switch. The second candidate cell is included in the at least one candidate cell. In some example embodiments, the first cell switch may be a LTM cell switch. Similar to the first cell switch, the second cell switch may be a LTM cell switch as well.

The first apparatus 110 then discards (230) CFRA resources for the second candidate cell. As used herein, the term “discard” may refer to a release of the CFRA resources, or retaining the CFRA resources but not using them anything else but RA procedure for a cell switch, such as, the first cell switch and/or the second cell switch. In some example embodiments, the first apparatus 110 may be disallowed to use the pre-provisioned CFRA resources for LTM recovery procedure, but first apparatus 110 maintains the configuration of them.

In some example embodiments, after discarding the CFRA resources for the second candidate cell, the first apparatus 110 may perform the second cell switch to the second candidate cell based on Contention Based Random Access (CBRA) resources.

In some example embodiments, the first apparatus 110 may discard the CFRA resources associated with the second candidate cell. In such case, the first apparatus 110 may discard the CFRA resources only for the selected LTM candidate cell. Alternatively or in addition, the first apparatus 110 may discard the CFRA resources associated with all of the at least one candidate cell. That is, the first apparatus 110 may discard the CFRA resources for all the LTM candidate cells. As a further alternative, the first apparatus 110 may discard the CFRA resources associated with a set of cells of the at least one candidate cell. In some examples, the set may be configured by the second apparatus 120.

In some example embodiments, the first apparatus 110 may discard the CFRA resources at a first time point that the second cell switch is initiated, or a second time point that the first cell switch fails, or a third time point that a random access procedure performed for the second cell switch is completed. In some example embodiments, the first apparatus 110 may discard the pre-provisioned CFRA resources upon initiating a LTM cell switch procedure for LTM recovery (i.e., after cell selection) or upon LTM cell switch failure (i.e., before cell selection) (RLF). In one example, the first apparatus 110 may discard the CFRA resources for the selected cell for LTM recovery only upon completion of the Random Access procedure performed for the LTM recovery procedure.

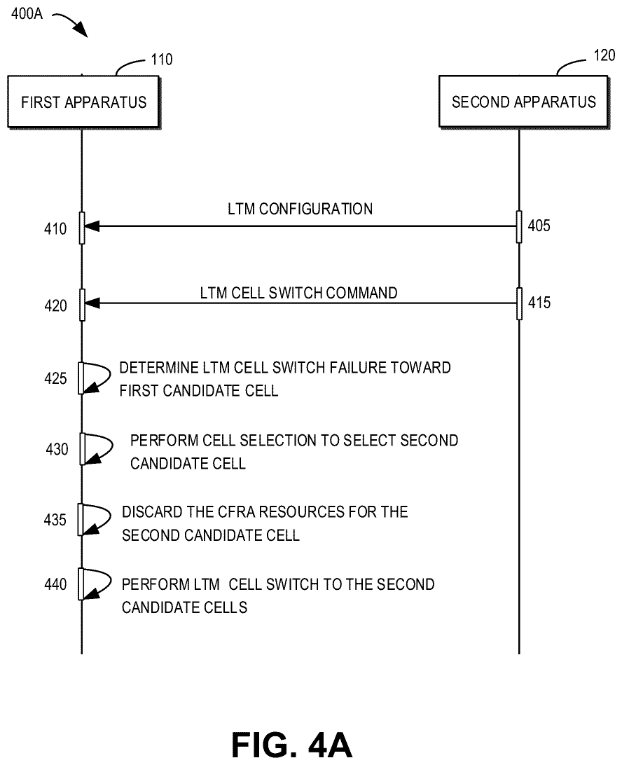

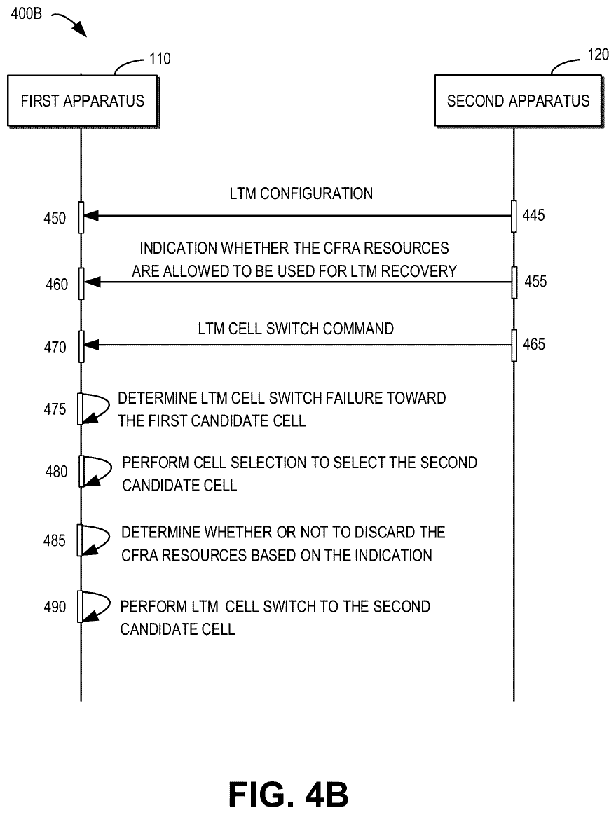

The following FIG. 4A illustrates a signalling flow 400A for handling CFRA resources according to some example embodiments of the present disclosure. The signalling flow 400A involves the first apparatus 110 and a second apparatus 120. For the purpose of illustration, some example embodiments may be described with the first apparatus 110 operating as a terminal device (for example, a UE) and the second apparatus 120 operating as a network device (for example, a gNB).

As shown in FIG. 4A, the second apparatus 120 transmits (405) a configuration, for example, an LTM configuration, to the first apparatus 110. The LTM configuration may be transmitted via a RRCReconfiguration message, and may at least indicate CFRA resources for a second candidate cell. In some implementations, the LTM configuration may also indicate CFRA resources for candidate cell(s) other than the second candidate cell. The first apparatus 110 receives (410) the LTM configuration and thus at least knows the CFRA resources for the second candidate cell.

The second apparatus 120 further transmits (415) a LTM cell switch command to the first apparatus 110 to indicate the first apparatus 110 to switch to a first candidate cell. The first apparatus 110 receives (420) the LTM cell switch command and then performs the first cell switch towards the first candidate cell. In some cases, the first apparatus 110 determines (425) that the first cell switch fails. The first apparatus 110 then performs (430) a cell selection to select a second candidate cell. After the cell selection, the first apparatus 110 may perform a LTM recovery procedure and/or a further cell switch (also referred to as the second cell switch) towards the second candidate cell. The first apparatus 110 then discards (435) the explicitly signalled CFRA resources for the second candidate cell and performs (440) the LTM cell switch to the second candidate cell using CBRA resources.

In some example embodiments, the second apparatus 120 may transmit an indication to the first apparatus 110. That is, the indication may be included in the configuration transmitted by the second apparatus 120. The indication may indicate whether the CFRA resources for a second candidate cell are allowed to be used for a second cell switch in a case where a first cell switch to a first candidate cell fails. In such cases, the second candidate cell is included in the at least one candidate cell. After receiving such indication, the first apparatus 110 discards the CFRA resources for the second candidate cell if the CFRA resources are not allowed to be used for the second cell switch. In such case, the second apparatus 120 may indicate if the pre-provisioned CFRA resources are allowed to be used for LTM recovery procedure. In some example embodiments, if the CFRA resources are not allowed to be used for the selected LTM candidate cell, the first apparatus 110 may discard the CFRA resources associated with the selected LTM candidate cell.

In some example embodiments, the indication may be candidate cell specific, terminal device specific, or common to all candidate cells, or specific to a set of candidate cells. That is, this indication can be LTM candidate cell specific or UE specific (i.e., a common indication for all LTM candidates).

In some example embodiments, the indication may be obtained from the cell switch command or received via a RRC signalling. Whether the first apparatus 110 is allowed to use the CFRA resource indicated in the LTM CSC MAC CE (in case that the selected cell for LTM recovery procedure is the target cell of the LTM procedure) for the LTM recovery procedure is indicated as a further indication separately in the LTM CSC MAC CE or in the RRC configuration.

In some example embodiments, the indication may further indicate whether the CFRA resources are to be discarded for the second candidate cell or for all of the at least one candidate cell. Further, the indication may include a time point for discarding the CFRA resources. The time point may be a first time point that the second cell switch is initiated. Alternatively, the time point may be a second time point that the first cell switch fails. In other case, the time point may indicate to discard the CFRA resources when a random access procedure performed for the second cell switch is completed. Therefore, the CFRA resource indicated in the LTM CSC MAC CE (in case that the selected cell for LTM recovery procedure is the target cell of the LTM procedure) may be always discarded upon failure of the LTM cell switch or upon initiating the LTM recovery procedure.

In some further example embodiments, the discarded CFRA resources may exclude CFRA resources for beam failure recovery (BFR). Thus, the first terminal device 110 may not discard BFR CFRA resources configured for the selected LTM candidate cell, if any.

In some example embodiments, at least one of the first cell switch or the second cell switch may be a Layer 1 or Layer 2 (L1/L2) triggered mobility (LTM) cell switch. As an example, the first apparatus may include a terminal device, and the second apparatus may include a network device.

The above embodiment is further discussed with reference to FIG. 4B, which illustrates a signalling flow 400B for handling CFRA resources according to some example embodiments of the present disclosure. The signalling flow 400B involves the first apparatus 110 and a second apparatus 120. For the purpose of illustration, some example embodiments may be described with the first apparatus 110 operating as a terminal device (for example, a UE) and the second apparatus 120 operating as a network device (for example, a gNB).

As shown in FIG. 4B, the second apparatus 120 transmits (445) a configuration, for example, an LTM configuration, to the first apparatus 110. The LTM configuration may be transmitted via a RRCReconfiguration message, and may at least indicate CFRA resources for a second candidate cell. In some implementations, the LTM configuration may also indicate CFRA resources for candidate cell(s) other than the second candidate cell. The first apparatus 110 receives (450) the LTM configuration and thus at least knows the CFRA resources for the second candidate cell.

As shown in FIG. 4B, the second apparatus 120 transmits (455) to the first apparatus 110 an indication, which indicates whether the CFRA resources for the second candidate cell are allowed to be used for a second cell switch in a case where a first cell switch to a first candidate cell fails. The indication may be included in the LTM configuration or may be transmitted separately, for example, via a separate RRC signalling. The first apparatus 110 receives (460) the indication from the second apparatus 120. Thus, the first apparatus 110 may be aware whether the discarding of the CFRA resources is allowed.

As shown in FIG. 4B, the second apparatus 120 may further transmit (465) a cell switch command, e.g., an LTM cell switch command, to the first apparatus 110 to indicate the first apparatus 110 to switch to a first candidate cell. It is to be understood that although in the example embodiments shown with respect to FIG. 4B, the indication indicating whether the CFRA resources are allowed to be used for the second cell switch is transmitted (455) via a separate message or signalling, this is just an example, rather than suggest any limitations. In other example embodiments, this indication may be transmitted via the cell switch command or in other suitable ways as well.

As to the first apparatus 110, it may receive (470) the cell switch command and then determine (475) that LTM cell switch first toward first candidate cell fails. Then, the first apparatus 110 may perform (480) a cell selection to select a second candidate cell. After the cell selection, the first apparatus 110 may perform a LTM recovery procedure and/or cell switch towards the second candidate cell. The first apparatus 110 determines (485) whether or not to discard the explicitly signalled CFRA resources based on the indication.

If the first apparatus 110 determines that the CFRA resources are to be discarded, the first apparatus 110 performs (490) the LTM cell switch to the second candidate cell using BCRA resources. Alternatively, If the CFRA resources is determined to be not discarded, the first apparatus 110 performs (490) LTM cell switch to the second candidate cell using the CFRA resources.

Some example implementation options into TS 38.331 for example embodiments of the present disclosure are provided in the following Table 5.

TABLE 5
5.3.7 RRC connection re-establishment
5.3.7.1 General
5.3.7.3 Actions following cell selection while T311 is running

| 1> | if the cell selection is triggered by detecting radio link failure of the MCG or | |
|---|---|---|
| | re-configuration with sync failure of the MCG or mobility from NR failure; and | |
| 1> | if attemptLTM-Switch is configured; and | |
| 1> | if the selected cell is one of the LTM candidate cells in the LTM-Candidate IE within | |
| | VarLTM-Config associated with the MCG: | |
| | 2> | discard any explicitly signalled contention-free Random Access Resources for |
| | | 2-step RA type and 4-step RA type except the 4-step RA type contention-free |
| | | Random Access Resources for beam failure recovery request, if any, for the |
| | | selected cell/for the LTM candidate cells; |
| | 2> | if attemptLTM-AllowedCFRA is set to false (OPTIONAL) for the selected cell: |
| | | 3> discard any explicitly signalled contention-free Random Access Resources for |
| | | 2-step RA type and 4-step RA type except the 4-step RA type contention-free |
| | | Random Access Resources for beam failure recovery request, if any, for the |
| | | selected cell/for the LTM candidate cells; |
| | 2> | perform the LTM cell switch procedure for the selected LTM candidate cell according |

to the actions specified in 5.3.5.x.6;

Some example implementation options into TS 38.321 for example embodiments of the present disclosure are provided in the following Table 6.

TABLE 6
5.1.2 Random Access Resource selection
If the selected RA_TYPE is set to 4-stepRA, the MAC entity shall:

| 1> | if the Random Access procedure was initiated for SpCell beam failure recovery (as | |
|---|---|---|
| | specified in clause 5.17); and | |
| 1> | if the beamFailureRecoveryTimer (in clause 5.17) is either running or not configured; and | |
| 1> | if the contention-free Random Access Resources for beam failure recovery request | |
| | associated with any of the SSBs and/or CSI-RSs have been explicitly provided by RRC; | |
| | and | |
| 1> | if at least one of the SSBs with SS-RSRP above rsrp-ThresholdSSB amongst the SSBs in | |
| | candidateBeamRSList or the CSI-RSs with CSI-RSRP above rsrp-ThresholdCSI-RS | |
| | amongst the CSI-RSs in candidateBeamRSList is available: | |
| | 2> | select an SSB with SS-RSRP above rsrp-ThresholdSSB amongst the SSBs in |
| | | candidateBeamRSList or a CSI-RS with CSI-RSRP above rsrp-ThresholdCSI-RS |
| | | amongst the CSI-RSs in candidateBeamRSList; |
| | 2> | if CSI-RS is selected, and there is no ra-PreambleIndex associated with the selected |

| CSI-RS: | |
|---|---|
| 3> | set the PREAMBLE_INDEX to a ra-PreambleIndex corresponding to the SSB in |

candidateBeamRSList which is quasi-colocated with the selected CSI-RS as specified
in TS 38.214 [7].

| | |
|---|---|
| 2> | else: |

| | |
|---|---|
| 3> | set the PREAMBLE_INDEX to a ra-PreambleIndex corresponding to the selected |

SSB or CSI-RS from the set of Random Access Preambles for beam failure recovery
request.

| 1> | else if the ra-PreambleIndex has been explicitly provided by PDCCH; and | |
|---|---|---|
| 1> | if the ra-PreambleIndex is not 0b000000: | |
| | 2> | set the PREAMBLE_INDEX to the signalled ra-PreambleIndex; |
| | 2> | select the SSB signalled by PDCCH. |
| 1> | else if the contention-free Random Access Resources associated with SSBs have been | |
| | explicitly provided in rach-ConfigDedicated and at least one SSB with SS-RSRP above | |
| | rsrp-ThresholdSSB amongst the associated SSBs is available; and | |
| 1> | if the Random Access procedure is not initiated for LTM cell switch for LTM | |
| | recovery (as specified in TS 38.331): | |
| | 2> | select an SSB with SS-RSRP above rsrp-ThresholdSSB amongst the associated SSBs; |
| | 2> | set the PREAMBLE_INDEX to a ra-PreambleIndex corresponding to the selected SSB. |
| 1> | else if the contention-free Random Access Resources associated with CSI-RSs have been | |
| | explicitly provided in rach-ConfigDedicated and at least one CSI-RS with CSI-RSRP | |
| | above rsrp-ThresholdCSI-RS amongst the associated CSI-RSs is available; and | |
| 1> | if the Random Access procedure is not initiated for LTM cell switch for LTM | |
| | recovery (as specified in TS 38.331): | |
| | 2> | select a CSI-RS with CSI-RSRP above rsrp-ThresholdCSI-RS amongst the associated |
| | | CSI-RSs; |
| | 2> | set the PREAMBLE_INDEX to a ra-PreambleIndex corresponding to the selected |
| | | CSI-RS. |
| 1> | else if the Random Access procedure was initiated for SI request (as specified in TS 38.331 | |
| | [5]); and | |
| 1> | if the Random Access Resources for SI request have been explicitly provided by RRC: | |
| | 2> | if at least one of the SSBs with SS-RSRP above rsrp-ThresholdSSB is available: |

| | |
|---|---|
| 3> | select an SSB with SS-RSRP above rsrp-ThresholdSSB. |

| | |
|---|---|
| 2> | else: |

| | |
|---|---|
| 3> | select any SSB. |

| | 2> | select a Random Access Preamble corresponding to the selected SSB, from the Random |
|---|---|---|
| | | Access Preamble(s) determined according to ra-PreambleStartIndex as specified in |
| | | TS 38.331 [5]; |
| | 2> | set the PREAMBLE_INDEX to selected Random Access Preamble. |
| 1> | else (i.e., for the contention-based Random Access preamble selection): | |
| | 2> | if at least one of the SSBs with SS-RSRP above rsrp-ThresholdSSB is available: |

| | |
|---|---|
| 3> | select an SSB with SS-RSRP above rsrp-ThresholdSSB. |

| | |
|---|---|
| 2> | else: |

| | |
|---|---|
| 3> | select any SSB. |

In view of the above, the NW can reuse the CFRA resources configured for LTM candidate cells configured for a UE performing LTM cell switch immediately to another UE. Further, the NW has the means to control whether the UE uses the CFRA resources for LTM recovery.

FIG. 5 shows a flowchart of an example method 500 implemented at a first apparatus in accordance with some example embodiments of the present disclosure. For the purpose of discussion, the method 500 will be described from the perspective of the first apparatus 110 in FIG. 1.

At block 510, the first apparatus 110 receives, from a second apparatus, a configuration indicating CFRA resources for at least one candidate cell.

At block 520, the first apparatus 110 receives, from the second apparatus, a cell switch command towards a first candidate cell.

At block 530, in accordance with a determination that a first cell switch to the first candidate cell fails, the first apparatus 110 determines a second candidate cell for a second cell switch, the second candidate cell being comprised in the at least one candidate cell.

At block 540, the first apparatus 110 discards CFRA resources for the second candidate cell.

In some example embodiments, the method 500 further comprises: performing the second cell switch to the second candidate cell based on Contention Based Random Access (CBRA) resources.

In some example embodiments, the CFRA resources are 4-step Random Access (RA) resources or 2-step RA resources.

In some example embodiments, the method 500 further comprises: discarding the CFRA resources associated with the second candidate cell, or discarding the CFRA resources associated with all of the at least one candidate cell.

In some example embodiments, the method 500 further comprises: discarding the CFRA resources at a first time point that the second cell switch is initiated, or a second time point that the first cell switch fails, or a third time point that a random access procedure performed for the second cell switch is completed.

In some example embodiments, the method 500 further comprises: receiving, from the second apparatus, an indication indicating whether the CFRA resources are allowed to be used for the second cell switch; and in accordance with a determination that the CFRA resources are not allowed to be used for the second cell switch, discarding the CFRA resources for the second candidate cell.

In some example embodiments, the indication is candidate cell specific or terminal device specific, or common to all candidate cells.

In some example embodiments, the indication is obtained from the cell switch command or received via a RRC signalling.

In some example embodiments, the indication further indicates whether the CFRA resources are to be discarded for the second candidate cell or for all of the at least one candidate cell.

In some example embodiments, the indication further indicates a time point for discarding the CFRA resources, the time point comprising one of: a first time point that the second cell switch is initiated, a second time point that the first cell switch fails, or a third time point that a random access procedure performed for the second cell switch is completed.

In some example embodiments, the discarded CFRA resources exclude CFRA resources for beam failure recovery.

In some example embodiments, at least one of the first cell switch or the second cell switch is a Layer 1 or Layer 2 (L1/L2) triggered mobility (LTM) cell switch.

In some example embodiments, the first apparatus comprises a terminal device, and the second apparatus comprises a network device.

FIG. 6 shows a flowchart of an example method 600 implemented at a second apparatus in accordance with some example embodiments of the present disclosure. For the purpose of discussion, the method 600 will be described from the perspective of the second apparatus 120 in FIG. 1.

At block 610, the second apparatus 120 transmits, to a first apparatus, a configuration indicating CFRA resources for at least one candidate cell.

At block 620, the second apparatus 120 transmits, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

In some example embodiments, the CFRA resources are 4-step Random Access (RA) resources or 2-step RA resources.

In some example embodiments, the indication is candidate cell specific or terminal device specific, or common to all candidate cells.

In some example embodiments, the indication is transmitted via a cell switch command towards a first candidate cell or via a Radio Resource Control (RRC) signalling.

In some example embodiments, the indication further indicates whether the CFRA resources are to be discarded for the second candidate cell or for all of the at least one candidate cell.

In some example embodiments, the indication further indicates a time point for discarding the CFRA resources, the time point comprising one of: a first time point that the second cell switch is initiated, a second time point that the first cell switch fails, or a third time point that a random access procedure performed for the second cell switch is completed.

In some example embodiments, the discarded CFRA resources exclude CFRA resources for beam failure recovery.

In some example embodiments, at least one of the first cell switch or the second cell switch is a Layer 1 or Layer 2 (L1/L2) triggered mobility (LTM) cell switch.

In some example embodiments, the first apparatus comprises a terminal device, and the second apparatus comprises a network device.

In some example embodiments, a first apparatus capable of performing any of the method 500 (for example, the first apparatus 110 in FIG. 1) may comprise means for performing the respective operations of the method 500. The means may be implemented in any suitable form. For example, the means may be implemented in a circuitry or software module. The first apparatus may be implemented as or included in the first apparatus 110 in FIG. 1.

In some example embodiments, the first apparatus comprises means for receiving, from a second apparatus, a configuration indicating CFRA resources for at least one candidate cell; means for receiving, from the second apparatus, a cell switch command towards a first candidate cell; means for in accordance with a determination that a first cell switch to the first candidate cell fails, determining a second candidate cell for a second cell switch, the second candidate cell being comprised in the at least one candidate cell; and means for discarding CFRA resources for the second candidate cell.

In some example embodiments, the first apparatus further comprises: means for performing the second cell switch to the second candidate cell based on Contention Based Random Access (CBRA) resources.

In some example embodiments, the CFRA resources are 4-step Random Access (RA) resources or 2-step RA resources.

In some example embodiments, the first apparatus further comprises: means for discarding the CFRA resources associated with the second candidate cell, or means for discarding the CFRA resources associated with all of the at least one candidate cell.

In some example embodiments, the first apparatus further comprises: means for discarding the CFRA resources at a first time point that the second cell switch is initiated, or a second time point that the first cell switch fails, or a third time point that a random access procedure performed for the second cell switch is completed.

In some example embodiments, the first apparatus further comprises: means for receiving, from the second apparatus, an indication indicating whether the CFRA resources are allowed to be used for the second cell switch; and means for in accordance with a determination that the CFRA resources are not allowed to be used for the second cell switch, discarding the CFRA resources for the second candidate cell.

In some example embodiments, the indication is candidate cell specific or terminal device specific, or common to all candidate cells.

In some example embodiments, the indication is obtained from the cell switch command or received via a Radio Resource Control (RRC) signalling.

In some example embodiments, the indication further indicates whether the CFRA resources are to be discarded for the second candidate cell or for all of the at least one candidate cell.

In some example embodiments, the indication further indicates a time point for discarding the CFRA resources, the time point comprising one of: a first time point that the second cell switch is initiated, a second time point that the first cell switch fails, or a third time point that a random access procedure performed for the second cell switch is completed.

In some example embodiments, the discarded CFRA resources exclude CFRA resources for beam failure recovery.

In some example embodiments, at least one of the first cell switch or the second cell switch is a Layer 1 or Layer 2 (L1/L2) triggered mobility (LTM) cell switch.

In some example embodiments, the first apparatus comprises a terminal device, and the second apparatus comprises a network device.

In some example embodiments, the first apparatus further comprises means for performing other operations in some example embodiments of the method 500 or the first apparatus 110. In some example embodiments, the means comprises at least one processor; and at least one memory storing instructions that, when executed by the at least one processor, cause the performance of the first apparatus.

In some example embodiments, a second apparatus capable of performing any of the method 600 (for example, the second apparatus 120 in FIG. 1) may comprise means for performing the respective operations of the method 600. The means may be implemented in any suitable form. For example, the means may be implemented in a circuitry or software module. The second apparatus may be implemented as or included in the second apparatus 120 in FIG. 1.

In some example embodiments, the second apparatus comprises means for transmitting, to a first apparatus, a configuration indicating CFRA resources for at least one candidate cell; and means for transmitting, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

In some example embodiments, the CFRA resources are 4-step Random Access (RA) resources or 2-step RA resources.

In some example embodiments, the indication is candidate cell specific or terminal device specific, or common to all candidate cells.

In some example embodiments, the indication is transmitted via a cell switch command towards a first candidate cell or via a Radio Resource Control (RRC) signalling.

In some example embodiments, the indication further indicates whether the CFRA resources are to be discarded for the second candidate cell or for all of the at least one candidate cell.

In some example embodiments, the indication further indicates a time point for discarding the CFRA resources, the time point comprising one of: a first time point that the second cell switch is initiated, a second time point that the first cell switch fails, or a third time point that a random access procedure performed for the second cell switch is completed.

In some example embodiments, the discarded CFRA resources exclude CFRA resources for beam failure recovery.

In some example embodiments, at least one of the first cell switch or the second cell switch is a Layer 1 or Layer 2 (L1/L2) triggered mobility (LTM) cell switch.

In some example embodiments, the first apparatus comprises a terminal device, and the second apparatus comprises a network device.

In some example embodiments, the second apparatus further comprises means for performing other operations in some example embodiments of the method 600 or the second apparatus 120. In some example embodiments, the means comprises at least one processor; and at least one memory storing instructions that, when executed by the at least one processor, cause the performance of the second apparatus.

FIG. 7 is a simplified block diagram of a device 700 that is suitable for implementing example embodiments of the present disclosure. The device 700 may be provided to implement a communication device, for example, the first apparatus 110 or the second apparatus 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has one or more communication interfaces to facilitate communication with one or more other modules or devices. The communication interfaces may represent any interface that is necessary for communication with other network elements. In some example embodiments, the communication module 740 may include at least one antenna.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The instructions of the program 730 may include instructions for performing operations/acts of some example embodiments of the present disclosure. The program 730 may be stored in the memory, e.g., the ROM 724. The processor 710 may perform any suitable actions and processing by loading the program 730 into the RAM 722.

The example embodiments of the present disclosure may be implemented by means of the program 730 so that the device 700 may perform any process of the disclosure as discussed with reference to FIG. 2 to FIG. 6. The example embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

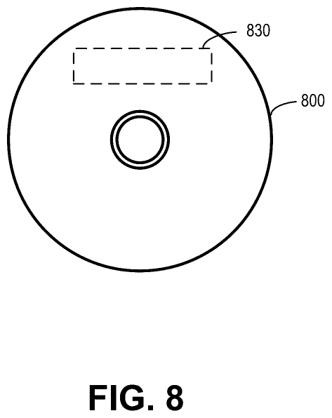

FIG. 8 shows an example of the computer readable medium 800 which may be in form of CD, DVD or other optical storage disk. The computer readable medium 800 has the program 730 stored thereon.

Generally, various embodiments of the present disclosure may be implemented in hardware or special purpose circuits, software, logic or any combination thereof. Some aspects may be implemented in hardware, and other aspects may be implemented in firmware or software which may be executed by a controller, microprocessor or other computing device. Although various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, although several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A first apparatus comprising:
at least one processor; and
at least one memory storing instructions that, when executed by the at least one processor, cause the first apparatus at least to:
receive, from a second apparatus, a configuration indicating contention free random access (CFRA) resources for at least one candidate cell;
receive, from the second apparatus, a cell switch command towards a first candidate cell;
in accordance with a determination that a first cell switch to the first candidate cell fails, determine a second candidate cell for a second cell switch,
the second candidate cell being comprised in the at least one candidate cell; and discard CFRA resources for the second candidate cell.

2. The first apparatus of claim 1, wherein the first apparatus is caused to:
perform the second cell switch to the second candidate cell based on Contention Based Random Access (CBRA) resources.

3. The first apparatus of claim 1, wherein the CFRA resources are 4-step Random Access (RA) resources or 2-step RA resources.

4. The first apparatus of claim 1, wherein the first apparatus is caused to:
discard the CFRA resources associated with the second candidate cell, or
discard the CFRA resources associated with all of the at least one candidate cell.

5. The first apparatus of claim 1, wherein the first apparatus is caused to:
discard the CFRA resources at a first time point that the second cell switch is initiated, or a second time point that the first cell switch fails, or a third time point that a random access procedure performed for the second cell switch is completed.

6. The first apparatus of claim 1, wherein the first apparatus is caused to:
receive, from the second apparatus, an indication indicating whether the CFRA resources are allowed to be used for the second cell switch; and
in accordance with a determination that the CFRA resources are not allowed to be used for the second cell switch, discard the CFRA resources for the second candidate cell.

7. The first apparatus of claim 6, wherein the indication is candidate cell specific or terminal device specific, or common to all candidate cells.

8. The first apparatus of claim 6, wherein the indication is obtained from the cell switch command or received via a Radio Resource Control (RRC) signalling.

9. The first apparatus of claim 6, wherein the indication further indicates whether the CFRA resources are to be discarded for the second candidate cell or for all of the at least one candidate cell.

10. The first apparatus of claim 6, wherein the indication further indicates a time point for discarding the CFRA resources, the time point comprising one of:
a first time point that the second cell switch is initiated,
a second time point that the first cell switch fails, or
a third time point that a random access procedure performed for the second cell switch is completed.

11. The first apparatus of claim 1, wherein the discarded CFRA resources exclude CFRA resources for beam failure recovery.

12. The first apparatus of claim 1, wherein at least one of the first cell switch or the second cell switch is a Layer 1 or Layer 2 (L1/L2) triggered mobility (LTM) cell switch.

13. The first apparatus of claim 1, wherein the first apparatus comprises a terminal device, and the second apparatus comprises a network device.

14. A second apparatus comprising:
at least one processor; and
at least one memory storing instructions that, when executed by the at least one processor, cause the second apparatus at least to:
transmit, to a first apparatus, a configuration indicating contention free random access (CFRA) resources for at least one candidate cell; and
transmit, to the first apparatus, an indication indicating whether the CFRA resources for a second candidate cell are allowed to be used for a second cell switch in a case where a first cell switch to a first candidate cell fails, the second candidate cell being comprised in the at least one candidate cell.

15. The second apparatus of claim 14, wherein the CFRA resources are 4-step Random Access (RA) resources or 2-step RA resources.

16. The second apparatus of claim 14, wherein the indication is candidate cell specific or terminal device specific, or common to all candidate cells.

17. The second apparatus of claim 14, wherein the indication is transmitted via a cell switch command towards a first candidate cell or via a Radio Resource Control (RRC) signalling.

18. The second apparatus of claim 14, wherein the indication further indicates whether the CFRA resources are to be discarded for the second candidate cell or for all of the at least one candidate cell.

19. The second apparatus of claim 14, wherein the indication further indicates a time point for discarding the CFRA resources, the time point comprising one of:
a first time point that the second cell switch is initiated,
a second time point that the first cell switch fails, or
a third time point that a random access procedure performed for the second cell switch is completed.

20. A method comprising:
receiving, from a second apparatus, a configuration indicating contention free random access (CFRA) resources for at least one candidate cell;
receiving, from the second apparatus, a cell switch command towards a first candidate cell;
in accordance with a determination that a first cell switch to the first candidate cell fails, determining a second candidate cell for a second cell switch, the second candidate cell being comprised in the at least one candidate cell; and
discarding CFRA resources for the second candidate cell.
